(19) United States
(12) Patent Application Publication
(10) Pub. No.: US 2024/0238813 A1
(43) Pub. Date: Jul. 18, 2024

(54) SHOWER DEVICE FOR GENERATING AT LEAST TWO WATER JET IMAGES

(71) Applicant: Dornbracht AG & Co. KG, Iserlohn (DE)

(72) Inventor: Marc Oehms, Balve (DE)

(21) Appl. No.: 18/397,289

(22) Filed: Dec. 27, 2023

(30) Foreign Application Priority Data
Dec. 27, 2022 (DE) 10 2022 134 860.1

(51) Int. Cl. B05B 1/18; B05B 1/06

(52) U.S. Cl. CPC B05B 1/185; B05B 1/06

(57) ABSTRACT

A shower device for producing at least two water jet patterns is provided. The shower device has a nozzle arrangement for dispensing water with a first group of nozzles for producing a first water jet pattern and a second group of nozzles for producing a second water jet pattern, a first shower head, which has the first group of nozzles and the second group of nozzles, and a plurality of water supply lines, via which water can be supplied to the first shower head. It is proposed that the water supply lines are designed as supply line and spacing units for supplying water to the first shower head and for spacing and fastening the first shower head in relation to a wall, in particular a ceiling.

### CLAIM OF PRIORITY

This application claims the benefit of German Patent application No. DE 10 2022 134 860.1 filed on Dec. 27, 2022, the disclosure of which is incorporated herein by reference.

### FIELD OF THE TECHNOLOGY

Various embodiments relate to a shower device for producing at least two water jet patterns, to a method for producing a water jet pattern, and to a shower system with a shower device and a wall.

### BACKGROUND

Shower devices are known in numerous embodiments and embodiment variants both in the private and the commercial sector. Shower devices are used wherever water is to be provided for personal hygiene. The water is provided in the form of water jet patterns by the shower devices, with the water jet patterns of the different shower devices being able to differ significantly. In private households, for example, water jet patterns which are formed from a plurality of individual water jets are regularly produced. In commercial facilities, for example such as in the hotel and wellness sector, there are, by contrast, often shower devices, which dispense a surge of water as the water jet pattern. In addition to the functional aspect of dispensing water, the focus is frequently also on aesthetics.

A shower device for producing at least one water jet pattern first of all has a nozzle arrangement. The nozzle arrangement permits the dispensing of water and provides, for example, different nozzles, which differ in particular in that they dispense the water in different ways and/or in that the nozzles are arranged in groups of nozzles positioned at different locations. The shower device further comprises a structural arrangement, which constitutes, for example, the supporting and/or stabilizing basic structure of the shower device and, for example, permits the arrangement of the shower device, e.g. on a wall, especially on a ceiling.

The known prior art (KR 2009 0006913 U), on which various embodiments are based, relates to a shower device which has a nozzle arrangement for dispensing water with a first group of nozzles for producing a first water jet pattern and a second group of nozzles for producing a second water jet pattern. The first group of nozzles and the second group of nozzles are part of a shower head which, in the mounted state, is incorporated in a ceiling. A plurality of water supply lines, via which water can be supplied to the shower head, run within the side wall and the ceiling of a shower area.

Although such shower devices have in the meantime become ever more widespread, since, in addition to use simply for personal hygiene, they also permit a shower experience with different water jet patterns, the type of water jet patterns is relatively limited. It is always a challenge, in the design and development of shower devices, especially for the hotel and wellness sector, to produce as many different types of water jet patterns as possible and which also have an aesthetic appearance and thus intensify the shower experience. In the case of the shower device known from the KR 2009 0006913 U, the design at least necessitates that the different groups of nozzles dispense the water, at different locations and with a different intensity, but always exclusively in the vertical direction, i.e. in the direction of gravity.

### SUMMARY

The problem on which various embodiments are based is to design and develop the known shower device in such a way that it is optimized with regard to the production of different types of water jet patterns, which at the same time also have an aesthetic appearance.

The above problem is solved by various embodiments provided herein.

The fundamental consideration is to arrange a nozzle arrangement for dispensing water with a first group of nozzles and a second group of nozzles in such a way that water can emerge spaced from the wall, in particular the ceiling, at unusual locations for the user and/or in unusual directions, as a result of which novel and particularly appealing water jet patterns can be produced. For this purpose, a shower head, which accommodates the first and the second group of nozzles, is spaced from the wall and/or ceiling by means of elongate spacers. The spacers, which are referred to below as supply line and spacing units, have a dual function and are designed both to supply water to the shower head and to fix the shower head in the room. This dual function of the water supply lines eliminates the need for additional suspension or fastening components for the shower head and, by means of the spacing from the wall and/or ceiling, there is now the option of dispensing water not only in one direction, for example vertically downwards parallel to the direction of gravity, but also upwards, such that the water of a corresponding water jet pattern describes an arc due to gravity, and this is perceived as being particularly aesthetic. In addition, the supply line and spacing units allow an unobtrusive fastening of the shower head and the creation of a seemingly floating design element.

Specifically, it is proposed that the water supply lines are designed as supply line and spacing units for supplying water to the first shower head and for spacing and fastening the first shower head in relation to a wall, in particular a ceiling.

According to various embodiments, a plurality of spatially separated water supply lines are provided, which permits a particularly appealing and elegant fastening of the shower head and thereby further enhances the impression of a seemingly floating design element.

In various embodiments, the water supply lines are specified in such a way that they are divided into water supply line groups, which can easily supply the different group of nozzles with water. Each of the water supply line groups has at least two water supply lines, and therefore each group of nozzles is supplied with water via a plurality of water supply lines and thus at different locations. As will be specified in more detail below, this leads over the entire extent of the group of nozzles to a particularly uniform dispensing of water.

According to various embodiments, different water jet patterns can be produced, each having a different course and/or a different orientation. In addition to different visual impressions that improve the shower experience, the different water jet patterns can also lead to different rainfall or falling of the water, especially in different directions in which the water is dispensed.

Various embodiments include a distribution system which permits the distribution of water within the shower head. An advantageous refinement with fluidically separated ring lines permits distribution with a low pressure loss and a simple design. An advantageous modular design of the distribution lines permits a cost-effective and in particular individually adaptable design of a distribution system.

According to various embodiments, the groups of nozzles are connected in groups to the distribution lines via nozzle connections. This reduces the number of components in the distribution system and thus also the mounting effort. The nozzle connections can act as connectors and as a connection, which can simplify the design of the distribution system.

Various embodiments relate to the modular design of the main body, which is formed from a plurality of main body modules. The modularity can, for example, simplify the manufacturing of the main body. Various embodiments make provision for the arrangement of the distribution line on the main body via the nozzle connections, and therefore the nozzle connections can also act as a type of arrangement element, thus enabling the number of components for the shower device to be reduced and the design of the shower head to be simplified.

Various embodiments specify the water supply line to the distribution lines. The supply line connections make it possible for water from the water supply lines to be supplied more uniformly into the distribution lines at different locations. The design of the first and/or second supply line connections as part of the main body leads to a structurally simple and easy-to-install design of the shower device. In addition, the supply line connections here can also permit the connection of the water supply lines to the shower head. A particularly uniform distribution of pressure within the distribution lines and an associated particularly uniform dispensing of water via the nozzles can be achieved in particular by the fact that the lengths of the line sections differ only to a small extent or do not differ at all from one another.

Various embodiments relate to a housing for protecting the shower head components accommodated in the housing from external influences and for producing an aesthetic appearance of the shower head. An in particular slot-shaped first outlet opening can permit water to be let out from the first group of nozzles and a second outlet opening formed in particular from a row of holes can permit the water to be let out from the second group of nozzles.

For the production of a further possible water jet pattern, a further refinement according various embodiments proposes to provide a second shower head in addition to the first shower head. This expands the water dispensing capabilities by the shower device. By arranging the shower heads at different, in particular horizontal, levels, space utilization can be optimized.

Various embodiments relate to a mounting arrangement with a mounting body, which permits the mounting on or in a wall. The mounting arrangement makes it possible for the shower device, in particular with the two shower heads, to be mounted in a simple manner on a wall or ceiling.

Various embodiments relate to an illumination arrangement for illuminating at least one of the water jet patterns, as a result of which the shower experience can be intensified in a particular way, in particular when, as per some embodiments, all of the water jet patterns of the different group of nozzles can be directly illuminated in the shower mode.

According to various embodiments a method for producing a water jet pattern with a shower device is provided.

A factor here is that the shower device is designed as proposed.

Reference may be made to all the embodiments of the proposed shower device.

Various embodiments relate to the production of different, particularly aesthetically pleasing water jet patterns.

According to various embodiments, a shower system with a shower device and a wall, in particular a ceiling, to which the shower device is fastened, is provided.

A factor here is that the shower device is designed as proposed.

Reference may be made to all the embodiments regarding the proposed shower device and the proposed method.

Various embodiments provide a shower device for producing at least two water jet patterns, wherein the shower device has a nozzle arrangement for dispensing water with a first group of nozzles for producing a first water jet pattern and a second group of nozzles for producing a second water jet pattern, a first shower head, which has the first group of nozzles and the second group of nozzles, and a plurality of water supply lines, via which water can be supplied to the first shower head, wherein the water supply lines are designed as supply line and spacing units for supplying water to the first shower head and for spacing and fastening the first shower head in relation to a wall, in particular a ceiling.

In various embodiments, the water supply lines are designed as spatially separated water supply lines, which are fastened at a distance from one another to the first shower head or can be fastened at a distance from one another to the wall, in particular the ceiling. In various embodiments, the water supply lines are arranged substantially parallel to one another and/or on a common first circular path or elliptical path.

In various embodiments, the water supply lines are divided into water supply line groups, in that water can be supplied to the first group of nozzles via a first water supply line group with at least two water supply lines and can be supplied to the second group of nozzles via a second water supply line group with at least two water supply lines, and in that the first water supply line group and the second water supply line group are separated from one another in terms of flow. In various embodiments, in that the water supply lines of the first water supply line group and the water supply lines of the second water supply line group are arranged substantially parallel to one another and/or on a common first circular path or elliptical path.

In various embodiments, the first group of nozzles has a plurality of first nozzles for dispensing water for the first water jet pattern and the second group of nozzles has a plurality of second nozzles for dispensing water for the second water jet pattern. In various embodiments, water can be dispensed in a first direction via the first nozzles and water can be dispensed in a second direction via the second nozzles, wherein the first direction is different from the second direction, in particular differs by at least 30°, by at least 60°, or by at least 90°, from the second direction. In various embodiments, the first direction is oriented downwards with respect to a horizontal plane and the second direction is oriented upwards with respect to the horizontal plane.

In various embodiments, the first shower head has a distribution system for distributing water from the water supply lines to the first group of nozzles and second group of nozzles, which distribution system has a first distribution line for distributing water to the first nozzles and a second distribution line for distributing water to the second nozzles, wherein the first distribution line can have a first ring line, on which the first nozzles are arranged, in particular at least partially equally spaced, and in that the second distribution line has a second ring line, on which the second nozzles are arranged, in particular at least partially equally spaced, wherein the first distribution line, in particular the first ring line, can be formed from a plurality of, in particular detachably, interconnected first line elements, and/or in that the second distribution line is formed from a plurality of, in particular detachably, interconnected second line elements.

In various embodiments, the first group of nozzles has a plurality of first nozzle connections, via which the first nozzles are connected in groups to the first distribution line, and/or in that the second group of nozzles has a plurality of second nozzle connections, via which the second nozzles are connected in groups to the second distribution line. In various embodiments, the first nozzle connections in each case connect two first line elements to one another and/or the second nozzle connections in each case connect two second line elements to one another. In various embodiments, the first ring line is formed from the first line elements and the first nozzle connections and/or the second ring line is formed from the second line elements and the second nozzle connections.

In various embodiments, the first shower head has a modular, in particular annular, main body, which is formed from a plurality of, in particular detachably, interconnected main body modules. In various embodiments, the first distribution line, in particular the first line elements and/or the first nozzles are arranged on the main body via the first nozzle connections and/or the second distribution line, in particular the second line elements and/or the second nozzles are arranged on the main body via the second nozzle connections.

In various embodiments, the distribution system has at least two first supply line connections, through each of which water from a water supply line of the first water supply line group can be supplied to the first distribution line, and in that the distribution system has at least two second supply line connections, through each of which water from a water supply line of the second water supply line group can be supplied to the second distribution line, wherein in particular the first supply line connections and/or the second supply line connections are formed as part of the main body, in particular in each case as part of a main body module. In various embodiments, the first supply line connections divide the first distribution line, in particular the first ring line, into a plurality of first line sections, wherein the lengths of the various first line sections differ from one another by at most 25%, at most 10%, at most 5%, or do not differ at all, and/or in that the second supply line connections divide the second distribution line, in particular the second ring line, into a plurality of second line sections, wherein the lengths of the different second line sections differ from one another by at most 25%, at most 10%, at most 5%, or do not differ at all.

In various embodiments, the first shower head has an, in particular annular, housing, in which the main body and/or the distribution system and/or the first group of nozzles and/or the second group of nozzles are accommodated. In various embodiments, the housing has an outlet opening, via which water from the first group of nozzles, in particular from the first nozzles, can be discharged from the interior of the housing to the outside, and/or has an outlet opening, via which water from the second group of nozzles, in particular from the second nozzles, can be discharged from the interior of the housing to the outside. In various embodiments, the outlet opening is designed as an outlet opening which is slot-shaped and/or curved and/or continuous and/or is formed from a row of holes.

In various embodiments, the first shower head has an, in particular circular or elliptical, jet passage opening, which is surrounded by the, in particular annular, housing, wherein water from the second group of nozzles, in particular from the second nozzles, passes through the jet passage opening in the shower mode.

In various embodiments, the shower device has a second shower head with a third group of nozzles for producing a third water jet pattern, which shower head has at least one third nozzle, and a third water supply line group with at least one water supply line. In various embodiments, the first shower head and the second shower head are spaced apart from each other at a shower distance, wherein the water supply lines of the first water supply line group and the second water supply line group space the first shower head and the second shower head apart from each other.

In various embodiments, the shower device has a mounting arrangement with an, in particular plate-like, mounting body for mounting on the wall, in particular the ceiling, on which the first shower head is arranged via the water supply lines of the first water supply line group and the second water supply line group and on which the second shower head is arranged. In various embodiments, the mounting body at least partially surrounds the second shower head.

In various embodiments, the shower device has an illumination arrangement for illuminating at least one of the water jet patterns by light with at least one light source. In various embodiments, all of the water jet patterns of the different groups of nozzles can be directly illuminated via the illumination arrangement in the shower mode. In various embodiments, the illumination arrangement is at least partially integrated in the second shower head in such a way that the light source of the illumination arrangement can be flowed around by the water from the third group of nozzles.

Various embodiments provide a method for producing a water jet pattern with a shower device according to the disclosure.

In various embodiments, a first water jet pattern produced with the shower device is conical, and/or in that a second water jet pattern produced with the shower device is formed in a sinking manner, and/or in that a third water jet pattern produced with the shower device is cylindrical.

Various embodiments provide a shower system with a shower device and a wall, in particular a ceiling, to which the shower device is fastened, wherein the shower device is designed according to the disclosure.

### BRIEF DESCRIPTION OF THE DRAWINGS

Various aspects are explained in more detail below with reference to a drawing merely illustrating exemplary embodiments. In the drawing

FIG. 1 shows a schematic illustration of a proposed shower system with a proposed shower device in perspective view from below,

FIG. 2 shows a sectional view of the shower device according to FIG. 1 in the shower mode, and

FIG. 3 shows a sectional view, orthogonal to the sectional view in FIG. 2, of a first shower head of the shower device according to FIG. 1.

### DETAILED DESCRIPTION

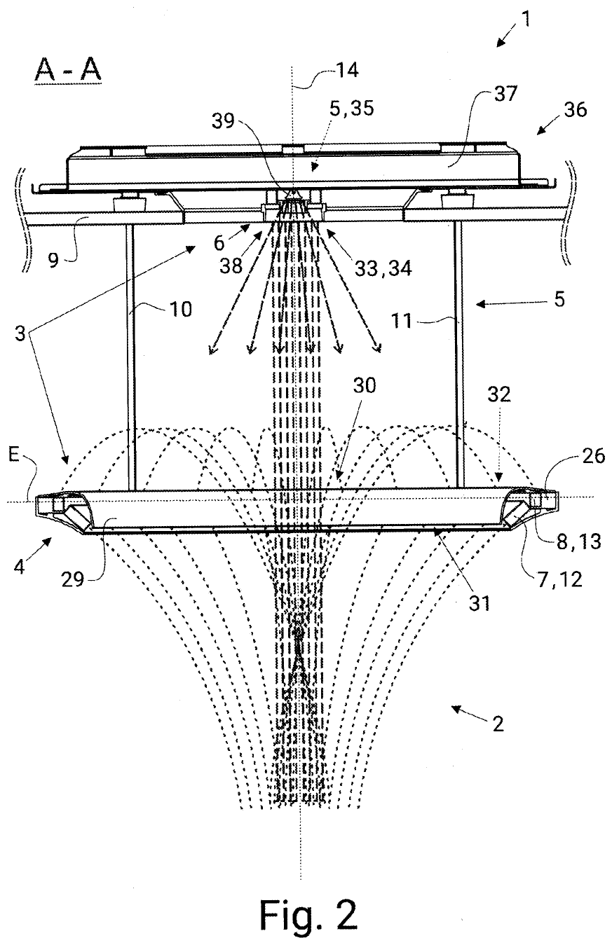

The exemplary embodiment which is illustrated in the figures relates to a shower device 1 for producing at least two water jet patterns 2. The water jet patterns 2 may include, for example, water jets and/or a water surge, as illustrated by way of example in FIG. 2. The water jet patterns 2 can be produced simultaneously or successively in the shower mode.

The shower device 1 has a nozzle arrangement 3, a first shower head 4 accommodating at least a part of the nozzle arrangement 3, and a plurality of water supply lines 5. A “first” shower head 4 does not mean that another, “second” shower head 6 absolutely also has to be provided; on the contrary, it may also be the only shower head. As will also be explained below, however, a second shower head 6 is also provided in the present exemplary embodiment.

The nozzle arrangement 3 now has a first group of nozzles 7 and a second group of nozzles 8 and permits the dispensing of water via them. By means of the first group of nozzles 7, a first water jet pattern 2 can be produced, and by means of the second group of nozzles 8, a second water jet pattern 2 can be produced. It is depicted by way of example in FIG. 2 that the first group of nozzles 7 produces a, in some embodiments conical, first water jet pattern 2 and the second group of nozzles 8 produces a second water jet pattern 2, such as formed in a sinking manner.

The first group of nozzles 7 and the second group of nozzles 8 are accommodated by the first shower head 4. It is conceivable that the nozzle arrangement 3 has further groups of nozzles, which are not accommodated by the first shower head 4. The first shower head 4, in various embodiments, can be annular and circular. Other forms are also conceivable, such as annular and elliptical.

Water can be supplied to the first shower head 4 via the water supply lines 5. The water supply lines 5, in various embodiments, are in each case tubular. The water supply lines 5, in various embodiments, are in each case rectilinear at least in sections. Furthermore, the water supply lines 5, in various embodiments, have a constant outer diameter, in each case at least in sections, in particular in a visible region.

It is now essential that the water supply lines 5 are designed as supply line and spacing units for supplying water to the first shower head 4 and for spacing and fastening the first shower head 4 in relation to a wall 9. A wall 9 is very generally meant here to mean any delimitation of the shower area. In particular, the term “wall” here also includes the ceiling of a shower area. A ceiling can be the ceiling of a bathroom or, for example, a suspended ceiling. Where a wall 9 is mentioned below, in the present exemplary embodiment the ceiling is meant. In principle, however, embodiments are also applicable to a side wall.

In this way, the nozzle arrangement 3 can be placed in the shower area during the mounting in such a way that water can emerge spaced from the wall 9 and/or ceiling at different locations and/or in different directions, for example even describing an arc due to gravity, as a result of which aesthetically particularly attractive water jet patterns 2 can be produced. In addition, the supply line and spacing units permit the production of a seemingly floating design element, which makes the overall aesthetic effect of the shower device 1 particularly attractive.

In various embodiments, the first shower head 4 in the mounted state is rigidly arranged with respect to the second shower head 6 and/or with respect to the wall 9. In this context, “rigid” means immovable, that is to say, during a shower mode as intended, the first shower head 4 is not movable with respect to the wall 9 and/or with respect to the second shower head 6, unlike, for example, a hand-held shower. However, the term “rigid” refers only to the mounted state as intended of the shower device 1, which therefore does not exclude adjustability during the mounting, in particular in order to change the shower spacing.

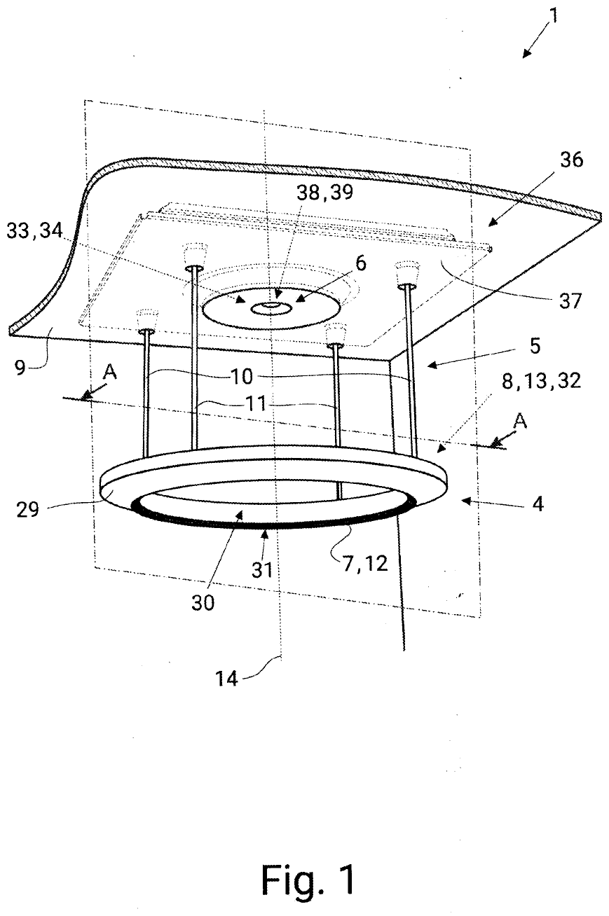

In various embodiments, it is provided that the water supply lines 5 are designed as spatially separated, that is to say, individual, water supply lines 5, which are fastened at a distance from one another to the first shower head 4, as it is illustrated by way of example in FIGS. 1 and 2. The water supply lines 5, in various embodiments, can in each case be tubular. It can be that the water supply lines 5 each have a rectilinear section which is arranged between the first shower head 4 and the wall 9.

In various embodiments, the water supply lines 5 of the first water supply line group 10 and the water supply lines 5 of the second water supply line group 11 are arranged substantially parallel to one another. In various embodiments, the water supply lines 5 of the first water supply line group 10 and the water supply lines 5 of the second water supply line group 11 are the same length and/or have the same diameter. It is possible for the water supply lines 5 to be oriented vertically, that is to say, in the direction of gravity, as is illustrated by way of example in FIGS. 1 and 2. Alternatively or in addition, the water supply lines 5 of the first water supply line group 10 and the water supply lines 5 of the second water supply line group 11 are arranged on a common first circular path, as can be seen by way of example from FIG. 1, or on a common elliptical path.

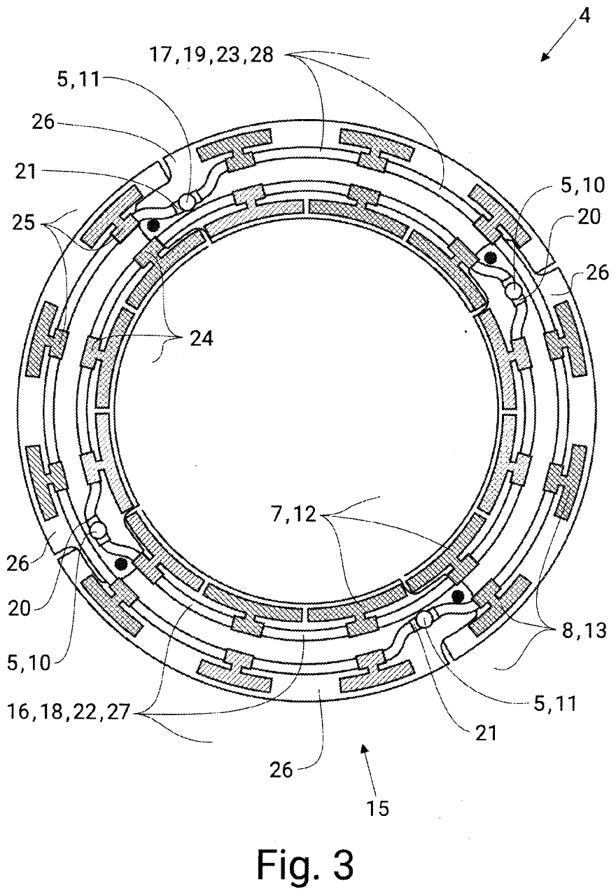

In various embodiments, as an overall view of FIG. 2 and FIG. 3 shows, the water supply lines 5 are divided into water supply lines groups, here into two water supply lines groups, wherein each water supply line group supplies water to another group of nozzles. Water can be supplied to the first group of nozzles 7 via a first water supply line group 10 with at least two water supply lines 5 and water can be supplied to the second group of nozzles 8 via a second water supply line group 11 with at least two water supply lines 5. In this case, the first water supply line group 10 and the second water supply line group 11 are formed separately from each other in terms of flow, in various embodiments, in such a way that the water supply lines 5 of the first water supply line group 10 and the water supply lines 5 of the second water supply line group 11 are arranged substantially parallel to one another and/or on a common first circular path or elliptical path.

When supplying the first and second group of nozzles 8 with water via in each case two water supply lines 5, a larger volume flow of water can be supplied to the corresponding group of nozzles than would be the case, for example, with a single water supply line 5. In particular in cases in which the first group of nozzles 7 and/or the second group of nozzles 8, for example, have a large number of first nozzles 12 or second nozzles 13, it is possible to ensure a uniform supply of water via the majority of the water supply lines 5 of each water supply line group, without having to accept unnecessarily high pressure losses.

Water can be supplied separately to the respective group of nozzles by the supply line via water supply line groups, which are formed separately from one another in terms of flow. For example, water can be conducted through the water lines of the first water supply line group 10 and supplied to the first group of nozzles 7, in particular to the first nozzles 12, while no water flows through the water lines of the second water supply line group 11 and therefore no water can be supplied to the second group of nozzles 8, in particular to the second nozzles 13. The first group of nozzles 7 and the second group of nozzles 8 can therefore be individually controlled. It is thus possible for either the first water jet pattern 2 or the second water jet pattern 2 to be produced individually or for the first water jet pattern 2 and the second water jet pattern 2 to be produced together.

Furthermore, in various embodiments, it is provided that the first group of nozzles 7 has a plurality of first nozzles 12 for dispensing water for the first water jet pattern 2 and the second group of nozzles 8 has a plurality of second nozzles 13 for dispensing water for the second water jet pattern 2. It is possible for the first group of nozzles 7, in particular the first nozzles 12, and the second group of nozzles 8, in particular the second nozzles 13, to be able to be controlled separately from one another via the water supply lines 5 of the first water supply line group 10 and of the second water supply line group 11. By this means, the water jet patterns 2 can be produced independently of one another. The first nozzles 12 and/or the second nozzles 13 may be designed as surge nozzles and/or as jet nozzles, to name just a few examples. In the exemplary embodiment according to FIG. 2, the first nozzles 12 and the second nozzles 13 are designed as jet nozzles.

Furthermore, in various embodiments, water can be dispensed in a first direction via the first nozzles 12 and water can be dispensed in a second direction via the second nozzles 13, and the first direction is different from the second direction.

In the present context, “different” means that the two directions differ from each other, in particular the first direction differs by at least 30°, by at least 60°, or by at least 90°, from the second direction.

Furthermore, it can be conceivable that the first direction is oriented downwards with respect to a horizontal plane E and the second direction is oriented upwards with respect to the horizontal plane E, as is apparent by way of example from FIG. 2. It is possible for the water of the second water jet pattern 2 to undergo a change in direction due to gravity. Also illustrated by way of example in FIG. 2, the first water jet pattern 2 is conical and the second water jet pattern 2 is formed in a sinking manner.

As illustrated by way of example in FIG. 3, at least some of the first nozzles 12, or in particular, all of the first nozzles 12, are arranged point-symmetrically with respect to a here vertical geometric main axis 14 of the first shower head 4. Alternatively or additionally, at least some of the second nozzles 13, or in particular all of the second nozzles 13, can be arranged point-symmetrically with respect to a here vertical geometric main axis 14 of the first shower head 4, wherein some of the second nozzles 13 are arranged differently spaced from one another in the circumferential direction, with reference to the here vertical geometric main axis 14 of the first shower head 4, as is also apparent by way of example from FIG. 3.

The main geometric axis 14 here is the central axis about which the first group of nozzles 7 and/or the second group of nozzles 8 extends. Said axis extends in particular in the vertical direction. The vertical direction here is the direction of gravity. Accordingly, the horizontal direction is the direction orthogonal thereto.

In various embodiments, it is furthermore the case that the first shower head 4 has an, in particular inner, distribution system 15 for distributing water from the water supply lines 5 to the first group of nozzles 7 and second group of nozzles 8, which distribution system has a first distribution line 16 for distributing water to the first nozzles 12 and a second distribution line 17 for distributing water to the second nozzles 13. It can be that the first distribution line 16 and the second distribution line 17 are separated from each other in terms of flow. This allows the separation of the water supply line groups in terms of flow to be maintained. FIG. 3 depicts the distribution system 15 by way of example.

As illustrated by way of example in FIG. 3, it is possible for the first distribution line 16 to have a first ring line 18, on which the first nozzles 12 are arranged, in particular at least partially equally spaced, and for the second distribution line 17 to have a second ring line 19, on which the second nozzles 13 are arranged, in particular at least partially equally spaced. The water can be guided circularly in the first ring line 18 and/or in the second ring line 19 for respectively supplying the first nozzles 12 and/or second nozzles 13 with water. It is conceivable for the first distribution line 16 and/or the second distribution line 17 in particular also to have one or more line elements, which lead away transversely from the first ring line 18 and/or second ring line 19. In particular, water can be fed into the first and/or second ring line 19 via one or more first supply line connections 20 and/or one or more second supply line connections 21. In various embodiments, the first ring line 18 and the second ring line 19 are each circular. Alternatively, the first ring line 18 and/or the second ring line 19 may also be designed in other forms, for example elliptically.

It is also possible for the first distribution line 16, in particular the first ring line 18, to be formed from a plurality of first line elements 22 which are interconnected, in particular detachably, in terms of flow, and/or for the second distribution line 17 to be formed from a plurality of second line elements 23 which are interconnected, in particular detachably, in terms of flow. In the exemplary embodiment of FIG. 3, the first ring line 18 has a plurality of detachably interconnected first line elements 22 and the second ring line 19 has a plurality of detachably interconnected second line elements 23.

Furthermore, in various embodiments, it is provided that the first group of nozzles 7 has a plurality of first nozzle connections 24, via which the first nozzles 12 are connected in groups to the first distribution line 16 in terms of flow, and/or that the second group of nozzles 8 has a plurality of second nozzle connections 25, via which the second nozzles 13 are connected in groups to the second distribution line 17. It can be possible in various embodiments, as illustrated by way of example in FIG. 3, that the first nozzle connections 24 are arranged uniformly spaced from one another on the first ring line 18, and/or that the second nozzle connections 25 are arranged uniformly spaced from one another on the second ring line 19.

In this context, “in groups” means that a nozzle connection connects at least two of the nozzles in question to the distribution line in question.

Furthermore, in various embodiments, it is provided that the first nozzle connections 24 in each case interconnect two first line elements 22, in particular detachably, and/or that the second nozzle connections 25 in each case interconnect two second line elements 23, in particular detachably, as illustrated by way of example in FIG. 3. The first nozzle connections 24 and/or the second nozzle connections 25 can in particular connect the respective line elements by latching and/or screwing.

It is further provided in various embodiments that the first ring line 18 is formed from the first line elements 22 and the first nozzle connections 24, and/or that the second ring line 19 is formed from the second line elements 23 and the second nozzle connections 25. The nozzle connections can to this extent be part of the ring line.

Furthermore, in various embodiments, it is provided that the first shower head 4 has a modular main body 26, which is formed from a plurality of main body modules 26 which are interconnected, in particular mechanically. As depicted in FIG. 3, the main body 26 is annular, in particular circular or elliptical. The main body modules 26, in various embodiments, can be detachably interconnected, in particular via a latching and/or screw connection. The main body modules 26, in various embodiments, can be formed identically or can be divided into a plurality of groups of main body modules 26, which are each formed identically.

It can also be that the first distribution line 16, in particular the first line elements 22, and/or the first nozzles 12 are arranged on the main body 26 via the first nozzle connections 24, and/or that the second distribution line 17, in particular the second line elements 23 and/or the second nozzles 13 are arranged on the main body 26 via the second nozzle connections 25. This is also illustrated by way of example in FIG. 3.

It is illustrated here and can be conceivable that the first nozzles 12, in particular the first group of nozzles 7, are arranged on a common second circular path or a common second elliptical path, and/or that the second nozzles 13, in particular the second group of nozzles 8, are arranged on a common third circular path or a common third elliptical path. In various embodiments, the second circular path or second elliptical path and the third circular path or third elliptical path are arranged concentrically, and/or the diameters of the second circular path and the third circular path or the main and secondary axes of the second elliptical path and the third elliptical path differ in size.

Furthermore, in various embodiments, it is provided that the distribution system 15 has at least two first supply line connections 20, through each of which water from a water supply line 5 of the first water supply line group 10 can be supplied to the first distribution line 16, in particular to the first ring line 18, and that the distribution system 15 has at least two second supply line connections 21, through each of which water from a water supply line 5 of the second water supply line group 11 can be supplied to the second distribution line 17, in particular to the second ring line 19. In FIG. 3, the main body 26 is annular and the two first supply line connections 20 and the two second supply line connections 21 are each arranged opposite each other in the first ring line 18, which is in particular also annular, or the second ring line 19, which in particular is also annular. The first supply line connections 20 and/or the second supply line connections 21, in various embodiments, can be point-symmetrical with respect to the here vertical geometric main axis 14 of the first shower head 4.

In various embodiments, it is possible for the first supply line connections 20 and/or the second supply line connections 21 to be designed as part of the main body 26, in particular in each case as part of a main body module 26. Here, the first supply line connections 20 and/or the second supply line connections 21 can be formed approximately integrally as part of one or more main body modules 26. The first supply line connections 20 and/or the second supply line connections 21 may in particular have three connections in terms of flow, in each case for connecting a water line of the first water supply line group 10 and two first line elements 22, or for connecting a water line of the second water supply line group 11 and two second line elements 23, as depicted, for example, in FIG. 3.

Various embodiments make provision for the first supply line connections 20 to divide the first distribution line 16, in particular the first ring line 18, into a plurality of first line sections 27, wherein the lengths of the different first line sections 27 differ from one another by at most 25%, at most 10%, or at most 5%. The first line sections 27 can comprise a plurality of first line elements 22. Alternatively or additionally, the second supply line connections 21 can divide the second distribution line 17, in particular the second ring line 19, into a plurality of second line sections 28, wherein the lengths of the different second line sections 28 differ from one another by at most 25%, most 10%, or at most 5%. The second line sections 28 can comprise a plurality of second line elements 23. In FIG. 3, it is depicted by way of example, that the different first line sections 27 differ by at most 5%, since they are substantially identical in length. In FIG. 3, the two first line sections 27 each comprise seven first line elements 22. Furthermore, it can be provided that the different second line sections 28 differ by at most 5%, since they are substantially identical in length. In FIG. 3, the two second line sections 28 each comprise seven second line elements 23.

Furthermore, in various embodiments, it is provided that the first shower head 4 has a housing 29, in which the main body 26 and/or the distribution system 15 and/or the first group of nozzles 7 and/or the second group of nozzles 8 are at least partially, in particular completely, accommodated. It can be provided that the housing 29 is annular, in particular circular or elliptical. In FIG. 1, the annular and circular housing 29 is illustrated by way of example. The annular housing 29 is formed circulating in the circumferential direction about the geometric main axis 14 and extends in a circulating manner around a flat, i.e. not annular, jet passage opening 30, the cross-sectional shape of which is defined by the annular shape of the housing 29 and to this extent is in particular circular or elliptical.

In various embodiments, the second group of nozzles 8 or the second nozzles 13 thereof are arranged and aligned such that, in the shower mode, the water of the second water jet pattern 2 at least partially, in some embodiments completely, passes through the jet passage opening 30 of the first shower head 4. This can be seen by way of example from FIG. 2. In this context, “completely” does not include spray or misdirected water from defective or dirty nozzles or the like, but rather refers only to the intended water jet pattern 2 in regular operation.

In various embodiments, it is the case that the housing 29 has a first outlet opening 31, via which water from the first group of nozzles 7, in particular from the first nozzles 12, can be discharged from the inside of the housing 29 to the outside. It is also possible that the first outlet opening 31 is formed as a slot-shaped, in particular curved, in some embodiments continuous, first outlet opening 31. FIG. 1 and FIG. 2 show, by way of example, the slot-shaped, curved and continuous first outlet opening 31, from which the water from the first nozzles 12 can be discharged from the inside of the housing 29 to the outside. FIG. 2 depicts, by way of example, the discharging of the water from the first outlet opening 31.

In various embodiments, if the housing 29 has a second outlet opening 32, via which water from the second group of nozzles 8, in particular from the second nozzles 13, can be discharged from the inside of the housing 29 to the outside. It is possible that the second outlet opening 32 is designed as a second outlet opening 32 formed from a row of holes. FIG. 2 illustrates, by way of example in cross section, the second outlet opening 32 which is formed from a row of holes and from which the water from the second nozzles 13 can be discharged from the inside of the housing 29 to the outside. FIG. 2 depicts, by way of example, the discharging of the water from the second outlet opening 32.

The outlet opening 31 should be understood as being “slot-shaped” if the ratio of its length to its width is at least 20 to 1, at least 45 to 1, or at least 60 to 1.

It has proven successful for the first group of nozzles 7, in particular the first nozzles 12, and/or for the second group of nozzles 8, in particular the second nozzles 13, to be accommodated in the housing 29 in such a way that the housing 29 in the shower mode is free from water from the first group of nozzles 7 and/or from the second group of nozzles 8. The water is thus discharged contactlessly with respect to the housing 29 from the first nozzles 12 and the second nozzles 13, as is shown, for example, in FIG. 2.

Furthermore, it can be provided that the shower device 1 has a second shower head 6 with a third group of nozzles 33 for producing a third water jet pattern 2, which has at least one third nozzle 34, and a third water supply line group 35 with at least one water supply line 5. The first shower head 4 is arranged in the mounted state in particular rigidly with respect to the second shower head 6. The second shower head 6 is apparent from FIG. 1. FIG. 2 depicts the third water jet pattern 2.

It is possible for the first shower head 4 and the second shower head 6 to be spaced from each other at a shower spacing, wherein the water supply lines 5 of the first water supply line group 10 and the second water supply line group 11 space the first shower head 4 and the second shower head 6 from each other. The shower spacing can be at least 20 cm, at least 30 cm, or at least 45 cm. The first shower head 4 and the second shower head 6, in various embodiments, are arranged coaxially to each other. It can be provided that the second shower head 6 is arranged relative to the first shower head 4 such that, in the shower mode, the water of the third water jet pattern 2 at least partially, in some embodiments completely, passes through the jet passage opening 30 of the first shower head 4. This can be seen by way of example from FIG. 2.

It may be provided that the first shower head 4 is a shower head away from the wall, and that the second shower head 6 is a shower head close to the wall, as is shown by way of example in FIG. 1. Furthermore, it is possible that the first water jet pattern 2 and/or the second water jet pattern 2 is or are in each case an outer water jet pattern 2, and/or that the third water jet pattern 2 is an inner water jet pattern 2.

In various embodiments, the first, second and third water supply line groups 35 can be controlled separately. The different water jet patterns 2 can thus be produced either individually or together or in groups.

Furthermore, in various embodiments, it is provided that the shower device 1 has a mounting arrangement 36 with an, in particular plate-like, mounting body 37 for mounting on a wall 9, here the ceiling, on which the first shower head 4 is arranged via the water supply lines 5 of the first water supply line group 10 and the second water supply line group 11 and on which the second shower head 6 is arranged, in various embodiments that the mounting body 37 at least partially surrounds the second shower head 6. As shown by way of example in FIG. 2, it is conceivable that the mounting body 37 is mounted on a ceiling of a bathroom and a suspended ceiling runs below the mounting body 37.

It is further provided, in various embodiments, that the shower device 1 has an illumination arrangement 38 for illuminating at least one of the water jet patterns 2 by light having at least one light source 39. In various embodiments, all of the water jet patterns 2 of the different groups of nozzles can be illuminated directly via the illumination arrangement 38 in the shower mode. In the present exemplary embodiment, the illumination arrangement 38 is at least partially integrated in the second shower head 6 in such a way that the light source 39 of the illumination arrangement 38 can be flowed around by the water from the third group of nozzles 33.

A method for producing a water jet pattern 2 with a proposed shower device 1 is proposed.

Reference may be made to all the embodiments of the proposed shower device 1.

Furthermore, in various embodiments, it is provided that a first water jet pattern 2 produced with the shower device 1 is conical, and/or that a second water jet pattern 2 produced with the shower device 1 is formed in a sinking manner, and/or in that a third water jet pattern 2 produced with the shower device 1 is cylindrical. In various embodiments, the water jet patterns 2 can be formed from a water surge and/or from a plurality of individual water jets.

In FIG. 2, by way of example, the first water jet pattern 2 is conical and formed from a plurality of individual water jets, and/or the second water jet pattern 2 is formed in a sinking manner and from a plurality of individual water jets, and/or the third water jet pattern 2 is cylindrical and formed from a circulating water surge.

Also proposed is a shower system with a shower device 1 and a wall 9, in particular a ceiling, wherein the shower device 1 is designed as proposed. In FIG. 1, an exemplary embodiment of the shower system is depicted by way of example.

Reference may be made to all the embodiments regarding the proposed shower device 1 and the proposed method.

1. A shower device for producing at least two water jet patterns, wherein the shower device comprises a nozzle arrangement for dispensing water with a first group of nozzles for producing a first water jet pattern and a second group of nozzles for producing a second water jet pattern, a first shower head, which comprises the first group of nozzles and the second group of nozzles, and a plurality of water supply lines, via which water can be supplied to the first shower head,
wherein the water supply lines are designed as supply line and spacing units for supplying water to the first shower head and for spacing and fastening the first shower head in relation to a wall.

2. The shower device according to claim 1, wherein the water supply lines are designed as spatially separated water supply lines, which are fastened at a distance from one another to the first shower head or are configured to be fastened at a distance from one another to the wall.

3. The shower device according to claim 1, wherein the water supply lines are divided into water supply line groups, wherein water can be supplied to the first group of nozzles via a first water supply line group with at least two water supply lines and can be supplied to the second group of nozzles via a second water supply line group with at least two water supply lines, and wherein the first water supply line group and the second water supply line group are separated from one another in terms of flow.

4. The shower device according to claim 1, wherein the first group of nozzles comprises a plurality of first nozzles for dispensing water for the first water jet pattern and the second group of nozzles comprises a plurality of second nozzles for dispensing water for the second water jet pattern.

5. The shower device according to claim 1, wherein the first shower head comprises a distribution system for distributing water from the water supply lines to the first group of nozzles and second group of nozzles, which distribution system comprises a first distribution line for distributing water to the first nozzles and a second distribution line for distributing water to the second nozzles.

6. The shower device according to claim 5, wherein the first group of nozzles comprises a plurality of first nozzle connections, via which the first nozzles are connected in groups to the first distribution line, and/or wherein the second group of nozzles comprises a plurality of second nozzle connections, via which the second nozzles are connected in groups to the second distribution line.

7. The shower device according to claim 1, wherein the first shower head comprises a modular main body, which is formed from a plurality of interconnected main body modules.

8. The shower device according to claim 5, wherein the distribution system comprises at least two first supply line connections, through each of which water from a water supply line of the first water supply line group can be supplied to the first distribution line, and wherein the distribution system comprises at least two second supply line connections, through each of which water from a water supply line of the second water supply line group can be supplied to the second distribution line, wherein the first supply line connections and/or the second supply line connections are formed as part of the main body, in each case as part of a main body module.

9. The shower device according to claim 5, wherein the first shower head comprises a housing, in which the main body and/or the distribution system and/or the first group of nozzles and/or the second group of nozzles are accommodated.

10. The shower device according to claim 9, wherein the first shower head comprises a jet passage opening, which is surrounded by the housing, wherein water from the second group of nozzles passes through the jet passage opening in the shower mode.

11. The shower device according to claim 1, wherein the shower device comprises a second shower head with a third group of nozzles for producing a third water jet pattern, which shower head comprises at least one third nozzle, and a third water supply line group with at least one water supply line, wherein the first shower head and the second shower head are spaced apart from each other at a shower distance, wherein the water supply lines of the first water supply line group and the second water supply line group space the first shower head and the second shower head apart from each other.

12. The shower device according to claim 11, wherein the shower device comprises a mounting arrangement with a mounting body for mounting on the wall on which the first shower head is arranged via the water supply lines of the first water supply line group and the second water supply line group and on which the second shower head is arranged.

13. The shower device according to claim 1, wherein the shower device comprises an illumination arrangement for illuminating at least one of the water jet patterns by light with at least one light source.

14. A method for producing a water jet pattern with a shower device according to claim 1.

15. The method according to claim 14, wherein a first water jet pattern produced with the shower device is conical, and/or wherein a second water jet pattern produced with the shower device is formed in a sinking manner, and/or wherein a third water jet pattern produced with the shower device is cylindrical.

16. A shower system with a shower device and a wall to which the shower device is fastened,
wherein the shower device is designed according to claim 1.

17. The shower device according to claim 2, wherein the water supply lines are arranged substantially parallel to one another and/or on a common first circular path or elliptical path.

18. The shower device according to claim 3, wherein the water supply lines of the first water supply line group and the water supply lines of the second water supply line group are arranged substantially parallel to one another and/or on a common first circular path or elliptical path.

19. The shower device according to claim 4, wherein water can be dispensed in a first direction via the first nozzles and water can be dispensed in a second direction via the second nozzles, wherein the first direction is different from the second direction.

20. The shower device according to claim 19, wherein the first direction is different from the second direction by at least 30°.
